(19) United States
(12) Patent Application Publication
(10) Pub. No.: US 2010/0315605 A1
(43) Pub. Date: Dec. 16, 2010

(54) IMAGE DISPLAY APPARATUS

(76) Inventor: Shinichi Arita, Osaka (JP)

Correspondence Address: BIRCH STEWART KOLASCH & BIRCH, PO BOX 747, FALLS CHURCH, VA, 22040-0747, US

(21) Appl. No.: 12/918,021

(22) PCT Filed: Feb. 16, 2009
(86) PCT No.: PCT/JP2009/052460

§ 371 Date: Aug. 17, 2010

(30) Foreign Application Priority Data
Feb. 18, 2008 (JP) 2008-036182

(51) Int. Cl. G03B 21/28; G03B 21/14

(52) U.S. Cl. 353/98; 353/101

(57) ABSTRACT

Provided is an image display apparatus which can reduce the influence of image quality degradation caused by a spot size on a screen generated when using a light source having a high directivity such as a laser beam and scan-type image formation means. The image display apparatus includes: a light source device (10) which emits light; scan-type image formation means (such as an MEMS mirror (14)) which forms an image on a screen (15); a variable focus device (13) arranged in the optical path of the light emitted from the light source device (10) to reach the image formation means; and control means which controls the variable focus device (13) so as to modify the spot size of the light beam projected onto the screen (15) in accordance with a projected image size or an user operation.

### TECHNICAL FIELD

The present invention relates to an image display apparatus, and, more particularly, to an image display apparatus using a highly directional light source such as a laser beam.

### BACKGROUND OF THE INVENTION

A projector (projection type image display apparatus) exists that displays an image by applying light from a light source device to a spatial light modulation element such as a liquid crystal panel for projecting the light on a screen. Conventionally, a lamp such as a high-pressure mercury lamp or a metal halide lamp is used as a light source of a projection type image display apparatus.

However, such a lamp has not only problems that a life time is short and that a long time is required for turning on but also requires an optical system for separating three primary colors of red, green, and blue from a light source, problems of low efficiency of use of light, complicated structure, and poor color reproducibility.

To solve these problems, an image display apparatus using a laser beam is recently proposed. Many improvements are expected by using a laser for a light source, such as a long life time, a wider color gamut, reduction of power consumption due to high efficiency of use of light, and miniaturization associated with the simplification of the optical system.

For example, Patent Document 1 discloses a projection type image display apparatus using a laser for a light source. The projection type image display apparatus has a light source portion made up of a laser light source device emitting three wavelengths of red, green, and blue and a light beam emitted from each laser is diffused to an appropriate spread and combined and made incident on a liquid crystal panel that is a spatial modulation element. The light incident on the liquid crystal panel is modulated in accordance with an image signal and projected on a screen by a projection lens to form an image on the screen.

Since a size of the spatial modulation element must be expanded to a beam diameter and the light must be equalized in an element surface, such a projection type image display apparatus using a spatial modulation element needs mechanisms such as a fly-eye lens and an optical integrator and is difficult to be miniaturized. Therefore, study has been made on combining a laser light source and a scanning type image forming apparatus to achieve miniaturization and several scanning type image forming apparatuses have been proposed that use a laser for a light source.

Patent Document 2 discloses a projection type image display apparatus that forms an image with a laser light source and a scanning type image forming means. The projection type image display apparatus uses a laser for the light source to generate light beams having wavelengths of red, green, and blue and, after the light beams are combined, the scanning type image forming means moves the light beam emitted on a screen in horizontal and vertical directions at high speed to form an image on the screen. Since this projection type image display apparatus allows a laser beam to reach the screen without expanding a beam diameter and therefore enables miniaturization of optical parts.

Patent Document 1: Japanese Laid-Open Patent Publication No. 2000-131762

Patent Document 2: Japanese Laid-Open Patent Publication No. 7-067064

### DISCLOSURE OF THE INVENTION

### Problems to be Solved by the Invention

As described in Patent Document 2, a projection type image display apparatus using a laser light source and a scanning type image forming means has a light beam reaching a screen with a spot size corresponding to a size of one pixel of an image. Therefore, since a degree of overlap of adjacent pixels is changed depending on a spot size on the screen, the spot size has a great impact on image quality. For example, when a light beam emitted from the image display apparatus is constant and has no spread, image quality deteriorates due to a gap between upper and lower spots formed when projection is performed with a larger size even though the spot size is optimum for a certain projection size. When the screen is brought closer to reduce the projection size, resolution drops and image quality deteriorates since a degree of overlap increases between the spots.

Therefore, a conventional projection type image display apparatus using a laser light source and a scanning type image forming means has a light beam emitted from the image display apparatus with a constant spread and is unable to maintain favorable image quality when a projected image size is changed. Although a spot size of alight beam on a screen must be changed depending on a projected image size for maintaining favorable image quality regardless of the projection size, such consideration has not conventionally been given.

Additionally, consideration has not been given to changing image quality in accordance with user's preferences in the conventional projection type image display apparatus using a laser light source and a scanning type image forming means.

The present invention was conceived in view of the situations and it is therefore the object of the present invention to provide an image display apparatus capable of controlling a spot size on a screen in accordance with an image projection size or user's operation so as to reduce an influence of image quality deterioration due to the spot size on the screen generated when using a highly directional light source such as a laser beam and a scanning type image forming means.

### Means for Solving the Problems

To solve the problems, a first technical means of the present invention is an image display apparatus comprises a light source device that emits a light beam; a scanning type image forming means that forms an image on a screen; a variable focus device disposed on a light path which the light beam emitted from the light source device reaches the image forming means; and a control means that controls the variable focus device to change a spot size of a light beam projected on the screen.

A second technical means is the first technical means wherein the control means has a projection size detecting means that detects a projection size and wherein the control means controls the variable focus device to change the spot size in accordance with the projection size detected by the projection size detecting means.

A third technical means is the second technical means wherein the projection size detecting means is a distance detecting means that detects a projection distance to the screen and wherein the control means controls the variable focus device to change the spot size in accordance with the projection size corresponding to the projection distance detected by the distance detecting means.

A fourth technical means is the first technical means wherein the control means has an operating means that accepts a user's operation for changing the spot size and wherein the control means controls the variable focus device to change the spot size in accordance with the user's operation accepted by the operating means.

A fifth technical means is any one of the first to fourth technical means wherein the variable focus device has an element capable of electrically controlling the spot size.

A sixth technical means is the fifth technical means, wherein the variable focus device has a liquid crystal lens as the element to change the spot size through voltage control applied to the liquid crystal lens.

A seventh technical means is the fifth technical means, wherein the variable focus device has a liquid lens as the element to change the spot size through voltage control applied to the liquid lens.

An eighth technical means is the fifth technical means, wherein the variable focus device has a variable focus mirror having a variable curved surface shape of the mirror as the element to change the spot size through voltage control applied to the variable focus mirror.

A ninth technical means is the eighth technical means, wherein the variable focus device controls a shape of a spot on the screen into a substantially rectangular shape.

A tenth technical means is anyone of the first to fourth technical means wherein the variable focus device has a plurality of lenses and a lens moving mechanism that moves at least one of the lenses in the light axis direction to change the spot size by moving the lens with the lens moving mechanism.

An eleventh means is any one of the first to tenth technical means wherein the control means has a tilt detecting means that detects a tilt of The screen and wherein the control means controls the variable focus device to change a spot size in a picture on the screen in accordance with the tilt detected by the tilt detecting means.

### Effect of the Invention

An image display apparatus of the present invention reduces an influence of image quality deterioration due to a spot size on a screen generated when using a highly directional light source such as a laser beam and a scanning type image forming means to consequently acquire equal image quality regardless of a projection size or to acquire a projected image having image quality preferred by a user.

### BRIEF DESCRIPTION OF THE DRAWINGS

FIG. 1 is a diagram of an exemplary configuration of an image display apparatus according to a first embodiment of the present invention.

FIG. 2 is a diagram of an exemplary configuration of an image display apparatus according to a second embodiment of the present invention.

FIG. 3 is a diagram of an exemplary configuration of an image display apparatus according to a third embodiment of the present invention.

FIG. 4 is a diagram of an exemplary configuration of a variable focus device according to the image display apparatus of FIG. 3.

FIG. 5 is a diagram of an example of arrangement of pixels formed on a screen under control of the variable focus device of FIG. 4.

FIG. 6 is a diagram of an exemplary configuration of an image display apparatus according to a fourth embodiment of the present invention.

FIG. 7 is a diagram of an exemplary configuration of an image display apparatus according to a fifth embodiment of the present invention.

### EXPLANATIONS OF REFERENCE NUMERALS

1, 2, 3, 6 . . . image display apparatus; 10 . . . laser light source device; 10a to 10c . . . laser light source; 11a to 11c . . . collimating lens; 12a to 12c . . . dichroic mirror; 13, 20, 30, 60 . . . variable focus device; 14 . . . MEMS mirror; 15 . . . screen; and 16 . . . distance detecting device.

### Preferred Embodiments of the Invention

An image display apparatus according to the present invention will now be described in terms of embodiments with reference to the drawings. The image display apparatus according to the present invention can exemplarily be illustrated by a projector and, particularly, it is more effective to incorporate the apparatus into mobile devices including a portable telephone. Although a subminiature laser projector is actually developed actively in consideration of incorporation into a portable telephone, etc., the problem of image quality deterioration due to a projection size is hardly solved in the current situation. The present invention is particularly useful for small devices such as mobile devices since favorable image quality is acquirable regardless of a projection size with a simple configuration described later.

### First Embodiment

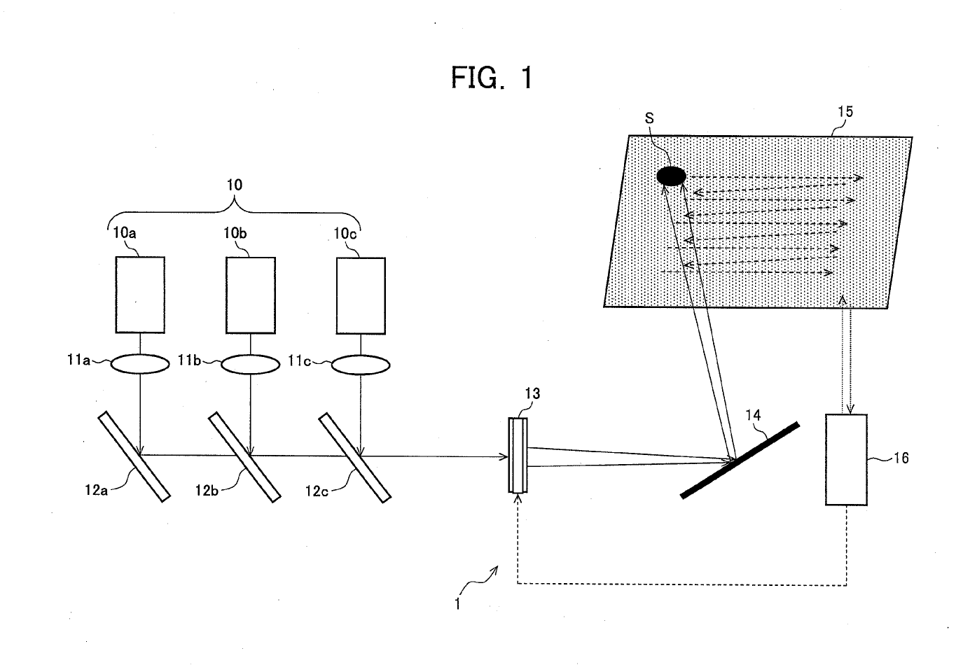

FIG. 1 is a diagram of an exemplary configuration of an image display apparatus according to a first embodiment of the present invention and, in FIG. 1, 1 denotes an image display apparatus.

The image display apparatus 1 depicted in FIG. 1 is made up of a laser light source device 10 made up of laser light sources 10a to 10c of R (red), G (green), and B (blue), collimating lenses 11a to 11c that collimate output light beams into parallel lights, dichroic mirrors 12a to 12c that only reflect wavelengths of their respective light beams, a variable focus device 13, a MEMS (Micro Electro Mechanical System) mirror 14 that forms an image with a scanning method, a screen 15 that displays an image, and a distance detecting device 16 that detects a distance to the screen 15. The variable focus device may be disposed on a light path of a light beam emitted from the laser light source device 10 and reaching the MEMS mirror 14.

For example, the laser light source device 10 may have the color laser light sources configured as follows. The laser light source 10a is configured as a semiconductor laser that emits a red laser beam; the laser light source 10b is configured as a laser that combines a semiconductor laser and an optical wave guide type SHG (Second Harmonic Generation) element to emit a green laser; and the laser light source 10c is configured as a semiconductor laser light source that emits a blue laser beam. The laser light source device 10 individually controls the intensities of lights emitted from the laser light sources 10a to 10c.

The laser light source may be a solid-state laser or a gas laser and the wavelength and type of the laser are not limited to those described herein. A plurality of lasers may be combined and, in this case, a laser beam with a higher intensity is acquirable to form a brighter image. Since a semiconductor laser is a small and highly efficient laser light source already mass-produced, the miniaturization of the apparatus and the bright image display can be achieved along with cost reduction. Among light sources other than a laser beam, the present invention may employ a light source that emits a highly directional light beam (a light beam traveling without spreading) like a laser beam.

The light beams emitted from the laser light sources 10a to 10c are respectively collimated by the collimating lenses 11a to 11c into parallel lights and entered on the dichroic mirrors 12a to 12c. The light beams incident on the dichroic mirrors 12a to 12c are combined into one light beam. Each of the dichroic mirrors 12a to 12c is a mirror that reflects only a specific wavelength. The dichroic mirror 12a, the dichroic mirror 12b, and the dichroic mirror 12c reflect a red light beam, a green light beam, and a blue light beam, respectively, to combine the laser beams into one beam. Although the dichroic mirrors are used for combination, another technique such as a cross prism may be used.

The light beam combined by the dichroic mirrors 12a to 12c enters the variable focus device 13. The variable focus device 13 has a liquid crystal lens and controls beam diameter of an outgoing light beam through an applied voltage to the liquid crystal lens.

More specifically, the liquid crystal lens is made up of glass substrates, a liquid crystal layer, and electrodes and is able to obtain a function equivalent to a lens by applying an electric field to the liquid crystal layer sandwiched between the glass substrates to change the refractive-index distribution of the liquid crystal layer such that a concentric gradient is formed in the refractive-index distribution. A focused light point of the light transmitted through the liquid crystal lens is freely controlled by controlling the intensity of the applied electric field to change the gradient of the refractive-index distribution.

The liquid crystal lens used in this exemplary configuration has a configuration having a liquid crystal layer disposed between two glass substrates and including a first electrode with a circular hole made of an aluminum thin film, etc., and a second electrode in a circular shape disposed in the hole portion on one of the grass substrates and a third electrode on the other. An electric field gradient axially symmetric to the central axis of the first electrode is formed by applying different electric fields to the first electrode and the second electrode and liquid crystal molecules are oriented in the electric field gradient direction to axially symmetrically form a refractive-index distribution of extraordinary light. Therefore, the liquid crystal lens has a function of a lens having an optical axis at the center of the hole of the first electrode. The electric field gradient formed between the third electrode layers opposed to the first electrode can be changed by changing the voltage applied to the second circular electrode. Therefore, the focal distance of the liquid crystal lens is freely changed by controlling the electric field applied to the second electrode

Although the liquid crystal lens of this embodiment has been described as a configuration including an electrode with a hole, this is not a limitation and any electrode configurations may be used as long as an axially symmetrical electric field distribution can be formed. For example, a plurality of concentrically arranged circular electrodes may be included to form an axially symmetrical electric field distribution in the liquid crystal layer by applying different voltages to the circular electrodes.

Since a liquid crystal lens includes a liquid crystal layer, it has a polarization characteristics and acts as a lens only for lights that have the same polarization direction. Therefore, the liquid crystal lens is disposed such that the polarization direction of the light beam from the laser light source device 10 has the same polarization direction of the liquid crystal to allow efficient control of a beam diameter in this exemplary configuration. If the polarization direction of the light beam emitted from the light source device is not a single direction unlike this exemplary configuration, all the polarization directions are supportable by including two or more liquid crystal layers and arranging one or more of the liquid crystal layers with different polarization directions. In this case, it is desirable to arrange the liquid crystal layers such that the vertical light distribution direction is achieved. However, since the configuration of the liquid crystal lens is more simplified when the polarization direction of the laser beam is conformed to the polarization characteristics of the liquid crystal and since the polarization control of the laser beam can easily be performed, it is more preferred to make the polarization direction of the light beam from the laser light source device 10 conform to the polarization property of the liquid crystal.

The light beam emitted from the variable focus device 13 is applied to the MEMS mirror 14 to form an image on the screen 15 using the scanning method. The MEMS mirror 14 is a two-axis MEMS mirror made up of an actuator and a micromirror to control the angle of the micromirror in the X-direction (horizontal direction) and the Y-direction (vertical direction). The light beam incident on the micromirror is reflected to scan the screen 15 (see dot-lines on the screen 15 of FIG. 1). Since the colors and intensities of the RGB laser beams are individually modulated and controlled, the color and intensity of the light emitted from the MEMS mirror 14 are controlled and projected on the screen 15 for each pixel of video to form an image by scanning at high speed as in a CRT (Cathode-ray Tube) display. Since an image is forms by scanning the laser beam on the screen and the spot size on the screen can be freely changed, the light beam emitted from the laser light source can be processed in the apparatus with the beam diameter (application spot diameter) kept as small as possible. Therefore, the apparatus and the optical members can be miniaturized and the price can also be reduced.

Although a two-axis MEMS mirror is used for the MEMS mirror 14 in this embodiment, two one-axis mirrors may be combined. In this case, one performs scanning in the horizontal direction and the other performs scanning in the vertical direction to acquire a two-dimensional image. Another scanning type image forming means may be provided instead of the MEMS mirror 14.

Since the beam diameter is controlled by the variable focus device 13 including the liquid crystal lens as above, a size of a spot S (spot size) of the light beam applied on the screen 15 is changed depending on the beam diameter. Therefore, the liquid crystal lens is an example of an element having a spot size that is electrically controllable.

For the control of the variable focus device 13, the image display apparatus 1 may include a control means. This control means is a means for controlling the variable focus device 13 such that the spot size of the light beam projected on the screen 15 is changed depending on the projection size. Although a means for detecting the projection size (a projection size detecting means) may use a method for actually detecting a screen size in a direct manner by using a camera, etc., this leads to a complicated configuration and, therefore, it is preferred to determine (calculate) the projection size of the projection from a projection distance as described below.

The distance detecting device 16 is mounted on the image display apparatus 1 as a portion of the control means. The distance detecting device 16 is made up of an infrared reflection sensor, etc., to detect (measure) a distance between the screen 15 and the image display apparatus 1. The distance detecting method is not limited to those using infrared and another method may be employed such as using ultrasonic sound for detecting the distance.

This control means may control the variable focus device 13 such that the spot size is changed depending on the projection distance by detecting the projection distance to the screen 15 with the distance detecting device 16. The origin of the distance in the image display apparatus 1 may be employed at any locations such as a position that is separated from the screen 15 by the same distance as separated from the MEMS mirror 14 and the control may accordingly be performed at the time of control.

More specifically, the control means calculates the projection size from the detected projection distance and the output angle of the MEMS mirror 14, obtains the beam diameter of the light beam in accordance with the calculated projection size, and transfers the information (control signal) to the variable focus device 13. The correlation between the projection size and the beam diameter may be performed in advance and stored inside as a conversion table, etc. The variable focus device 13 controls the beam diameter in accordance with the control signal. The spot size 15 on the screen 15 is suitably adjusted for the projection size in this way. Naturally, when the control means calculates the projection size, the information thereof may be transferred to the variable focus device 13 and the variable focus device 13 may control the beam diameter of the light beam in accordance with the projection size to suitably adjust the spot size 15 on the screen 15 for the projection size.

If the number of pixels of image data is constant (e.g., 1290×1080 pixels in the case of video for HDTV (High Definition Television)), the screen size increases as the projection distance is elongated and, therefore, the spot size (pixel size) may accordingly be increased. If the projection distance is long and the screen size is large, the control means may control to increase the spot size on the screen 15 and, contrary, if the projection distance is short and the screen size is small, the control means may control to reduce the spot size on the screen 15 to adjust a gap between pixels and a degree of overlap. Usually, the projection angle is a value specific to a projector determined depending on the performance of MEMS mirror 14, etc., and the screen size and the projection distance are basically in a proportional relation. Therefore, as the projection distance is elongated, the spot size may be changed to a larger size.

Complementarily describing the image quality, when the scanning type image display apparatus 1 moves the light beam at high speed on the screen 15 as depicted in FIG. 1 to form an image, the light beam is usually moved in the horizontal direction and then in the vertical direction in a sequential manner. Assuming that the projection sizes are the same, since the intervals are constant in the vertical direction, if the spot size is small, the image quality deteriorates because the gaps between pixels (especially between upper and lower pixels) become noticeable and, contrary, if the spot size is large, the image quality deteriorates because the degree of overlap is increased between pixels and the image is blurred as a whole. In other words, assuming that the laser beam is converted into a completely collimated (parallel) light, since the spot size is always constant, the gaps between pixels becomes noticeable if the projection size is large and, contrary, the overlap between pixels is increased if projected at a closer distance. Although the spread of the laser beam (i.e., spot size) must therefore be controlled in accordance with the projection size, such image quality deterioration does not occur since the control is easily performed in this embodiment. Although it is conceivable to use a technique of suitably coordinating a relationship between the spread angle of the laser beam and the projection size without a control mechanism for the beam diameter, it is practically difficult to make the spread angle of the laser beam constant in all the apparatuses and since a slight overlap between pixels affects image quality, it is difficult to always acquire the optimum image. On the other hand, this embodiment enables the beam diameter to be adjusted with a simple configuration to acquire the optimum image.

As described above, the image display apparatus 1 is provided with the variable focus device 13 that uses a liquid crystal lens having a focal distance changed by the electric field applied to the light path of the light beam emitted from the laser light source and varies the beam diameter of the light beam to change the spot size on the screen 15. This makes it possible to obtain favorable image quality regardless of a projected screen size, and to prevent the deterioration of the image quality due to a projection size.

Since a means for detecting a projection size is provided to drive the variable focus device 13 in accordance with the projection size, adjustment can automatically be performed to achieve optimum image quality. Particularly, since the distance detecting device 16 detects a projection distance to calculate a projection size and the variable focus device 13 is driven by the control signal thereof, adjustment can be performed to achieve optimum image quality with a simpler configuration regardless of the projection size.

Since the focal distance is controllable through electric control such as changing the voltage applied to the liquid crystal lens, the variable focus device 13 does not need to have a mechanical mechanism and is consequently possible to be configured as a simple small device, to prevent the shortening of life time, to have no mechanical failure, and to prevent noises.

### Second Embodiment

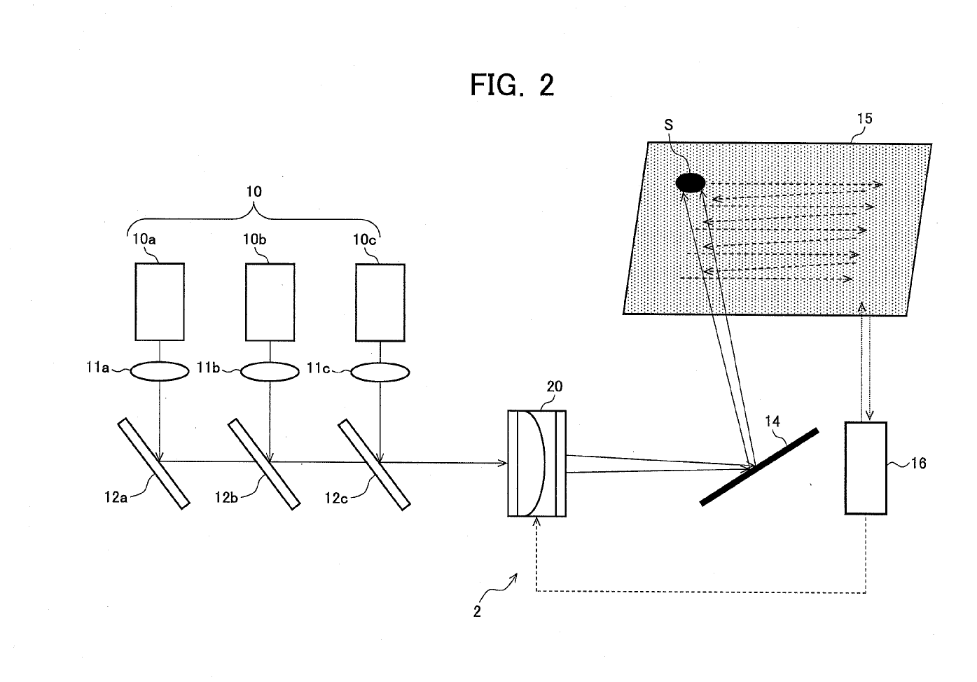

FIG. 2 is a diagram of an exemplary configuration of an image display apparatus according to a second embodiment of the present invention and, in FIG. 2, 2 denotes an image display apparatus. In FIG. 2, the same portions as those in the image display apparatus 1 of the first embodiment are denoted by the same reference numerals and will briefly be described by omitting a part of the description including application examples. The description for the method of improving image quality in accordance with a projection size is also the same as that for the first embodiment.

The image display apparatus 2 depicted in FIG. 2 is made up of the laser light source device 10 made up of the laser light sources 10a to 10c of R, G, and B, the collimating lenses 11a to 11c that collimate output light beams into parallel lights, the dichroic mirrors 12a to 12c that only reflect wavelengths of their respective light beams, a variable focus device 20 including a liquid lens, the MEMS mirror 14 that forms an image in a scanning method, the screen 15 that displays an image, and the distance detecting device 16 that detects a distance to the screen 15.

The light beams emitted from the R, G, and B laser light sources are collimated by the collimating lenses 11a to 11c into parallel lights. The laser beams collimated into parallel lights are combined by the dichroic mirrors 12a to 12c to form one light beam. The combined laser beam enters the variable focus device 20 disposed on the light path of the light beam.

The beam diameter of the incident light beam is changed by the variable focus device 20. The variable focus device 20 of this embodiment is made up of a liquid lens as an example of an element capable of electrically controlling the spot size. The liquid lens includes, for example, aqueous solution and oil forming two layers between glass substrates and the curvature of the boundary surface can be changed between the aqueous solution and the oil by applying a voltage to the layers. Since refractive indexes are different on both sides of the boundary surface between the aqueous solution and the oil, the light beam is refracted by the boundary surface. Therefore, the function of lens is achieved by controlling the curvature, thereby freely changing the focal distance. Since the focal point is made variable by simply controlling the applied voltage, the variable focus device 20 needs no driving mechanism and can be miniaturized. Since the liquid lens has no polarization characteristics, it is not necessary to match the polarization property of the laser light source with the liquid lens. Since the liquid lens has higher response speed of several tens of milliseconds, the spot size can be controlled at high speed.

The light beam emitted with the beam diameter changed by the variable focus device 20 comes to the MEMS mirror 14. The light beam is projected on the screen 15 by the two-axis MEMS mirror 14 to form an image on the screen 15 in the scanning method. The spot size of the light beam projected on the screen 15 is changed depending on the projection size by the variable focus device 20 under control of the control means to prevent the deterioration of image quality. In the same manner as the first embodiment, the variable focus device 20 is driven by the control signal corresponding to the projection size acquired using infrared by the distance detecting device 16.

In this embodiment, the variable focus device has the liquid lens and the liquid lens changes the beam diameter of the light beam and controls the spot size of the light beam on the screen 15 to prevent the deterioration of image quality due to the projection size. Thereby, the configuration is simplified, the size and cost can be reduced.

### Third Embodiment

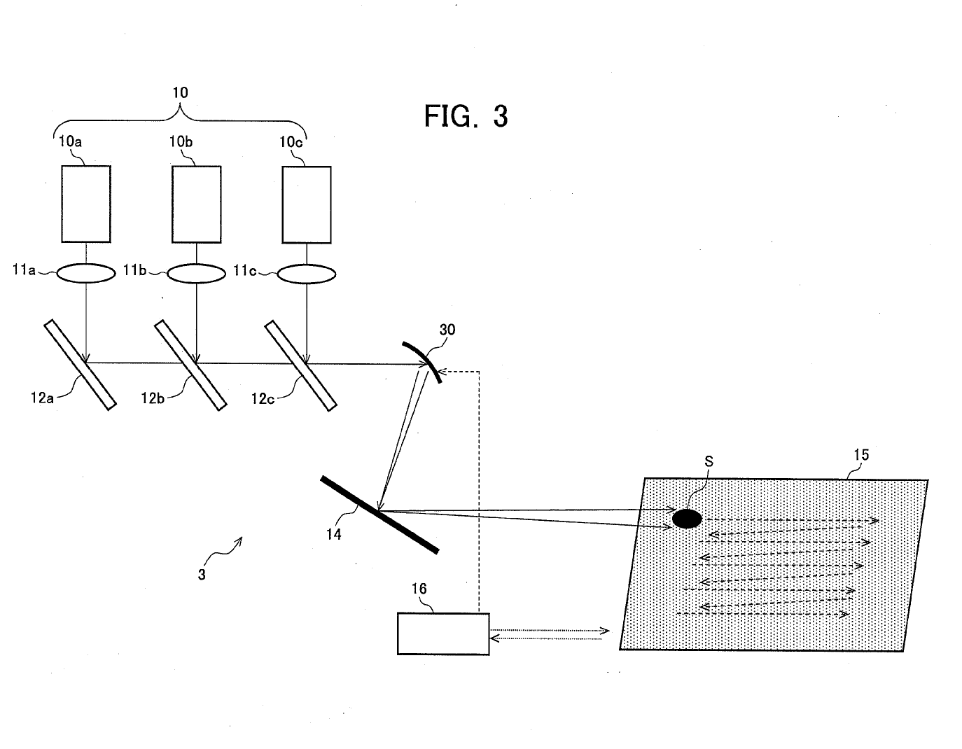

FIG. 3 is a diagram of an exemplary configuration of an image display apparatus according to a third embodiment of the present invention and, in FIG. 3, 3 denotes an image display apparatus. In FIG. 3, the same portions as those in the image display apparatus 1 of the first embodiment are denoted by the same reference numerals and will briefly be described by omitting a part of the description including application examples. The description for the reduction of the image quality deterioration due to the projection size is also the same as that of the first embodiment.

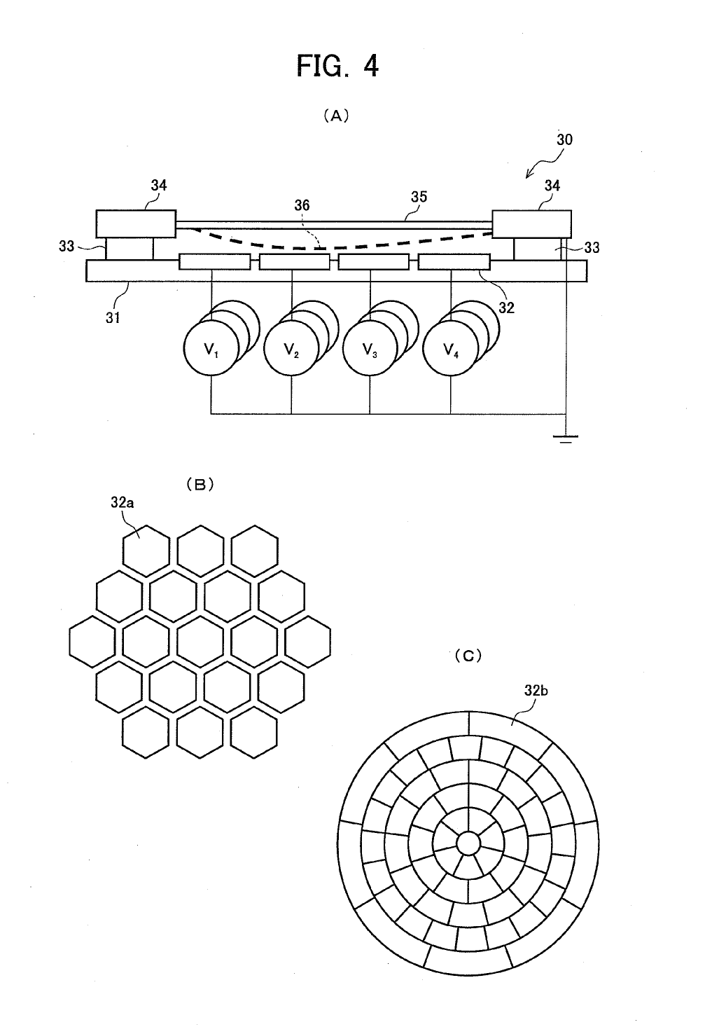

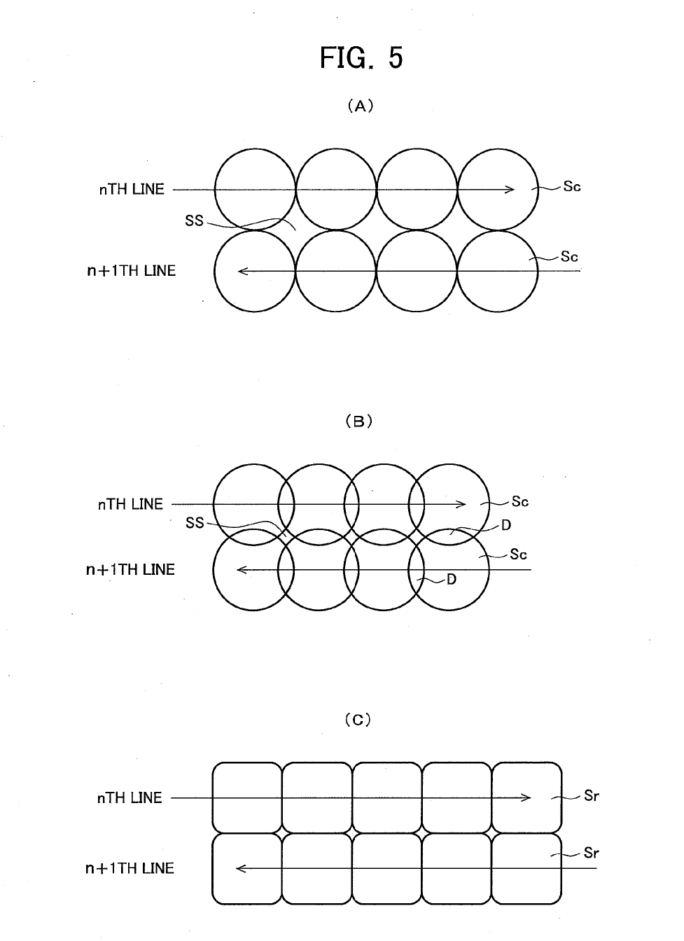

FIG. 4 is a diagram of an exemplary configuration of a variable focus device according to the image display apparatus of FIG. 3 and FIG. 5 is a diagram of an example of arrangement of pixels formed on a screen under control of the variable focus device of FIG. 4.

The image display apparatus 3 depicted in FIG. 3 is made up of the laser light source device 10 made up of the laser light sources 10a to 10c of R, G, and B, the collimating lenses 11a to 11c that collimate output light beams into parallel lights, the dichroic mirrors 12a to 12c that only reflect wavelengths of their respective light beams, a variable focus device 30 including a variable focus mirror, the MEMS mirror 14 that forms an image in a scanning method, the screen 15 that displays an image, and the distance detecting device 16 that detects a distance to the screen 15.

The image display apparatus 3 collimates the light beams emitted from the R, G, and B laser light sources with the collimating lenses 11a to 11c into parallel lights. The laser beams collimated into parallel lights are combined by the dichroic mirrors 12a to 12c to form one light beam. The combined laser beam enters the variable focus device 30 disposed on the light path of the light beam.

The beam diameter of the incident light beam is changed by the variable focus device 30. The variable focus device 30 of this embodiment is made up of a variable focus mirror as an example of an element capable of electrically controlling the spot size. Since the variable focus mirror can freely change the shape of the mirror in accordance with an applied voltage, the beam diameter of the light beam can be changed by reflecting the incident light beam by this mirror.

For the variable focus mirror, an electrostatic attractive force type may be employed, for example. As depicted in FIG. 4(A), a plurality of small electrodes 32 is disposed on the back side of a membrane mirror (membrane) 35 that is a thin-film reflective surface and the surface of the membrane mirror 35 is attracted by an electric attracting force to change the shape of the membrane mirror 35 as exemplarily illustrated by reference numeral 36. By controlling the voltage applied to the electrode 32, the curved surface shape of the membrane mirror 35 is changed to vary the beam diameter of the reflected light. Since the variable focus mirror can be miniaturized and has high response speed, the operability is improved. In FIG. 4(A), the electrodes 32 are arranged on a substrate 31 and the membrane mirror 35 is interposed between anchors 34 over the substrate 31 via spacers 33. The arrangement of the electrode 32 may be a honeycomb type having a plurality of electrodes 32a as depicted in FIG. 4(B) or a coaxial type having a plurality of electrodes 32b as depicted in FIG. 4(C).

The light beam emitted with the beam diameter changed by the variable focus device 30 enters the MEMS mirror 14. The light beam is projected on the screen 15 by the two-axis MEMS mirror 14 to form an image on the screen 15 in the scanning method. The spot size of the light beam projected on the screen 15 is changed depending on the projection size by the variable focus device 30 under control of the control means to prevent the deterioration of image quality. In the same manner as the first embodiment, the variable focus device 30 is driven by the control signal corresponding to the projection size acquired using infrared by the distance detecting device 16.

Although the variable focus mirror is normally controlled to vary the curvature to change the position of the focused light point, the variable focus mirror can be changed to a free curved surface shape by controlling each of a plurality of the small electrodes 32 arranged on the rear side of the membrane mirror 35. Therefore, the variable focus device 30 can change the reflective surface of the membrane mirror 35 to a complex shape with an applied voltage pattern to the electrodes 32, and change the spot shape of the incoming beam (having a circular cross-section) to, for example, a shape close to a rectangle instead of circle. Therefore, the variable focus device 30 can also control to change the shape of the spot on the screen 15 such as controlling the spot shape of the light beam on the screen 15 from a circular shape to a substantially rectangle shape.

In the case of a spot Sc having the shape of a circle as depicted in FIG. 5(A), a gap SS is formed between the spots Sc. If the gap is filled without changing the circular spot Sc, an overlapping portion D of the spots Sc is generated as depicted in FIG. 5(B) and a difference from a non-overlapping portion is generated, and the image quality is deteriorated. In contrast, by changing the spot shape to a rectangle (forming a rectangle spot Sr) as depicted in FIG. 5(C), a gap between pixels as well as the overlapping portion can be reduced to achieve improvement of the image quality.

As described above, in addition to the effect of the first or second embodiment, this embodiment enables the variable focus device to change the spot shape on the screen by using the variable focus mirror. Therefore, a degree of overlap between pixels can be equalized to further improve the image quality. Since a drive voltage is relatively low, power consumption is reduced to keep cost low. The efficient spot size control is achieved by increasing the reflectance of the reflective surface to acquire brighter images.

The variable focus device 30 may not be the electrostatic attractive force type described in the example. For example, a piezo actuator type variable focus mirror may be employed. The piezo actuator type variable focus mirror has a piezo actuator disposed on the rear side of the thin-film mirror to change the shape of the mirror due to expansion and contraction of a piezo element. Therefore, the spot size of the light beam can be controlled by means of the applied voltage to the piezo element. Since the piezo actuator type variable focus mirror is inexpensive, cost can be kept low. Since the variable focus mirror is a reflection type variable focus device and is independent of light absorption (transmissivity) of a material like the transmission type, the efficient spot size control is achieved by improving the reflectance of the reflective surface. Since the variable focus mirror is driven even with a relatively low control voltage, power consumption can be kept low.

### Fourth Embodiment

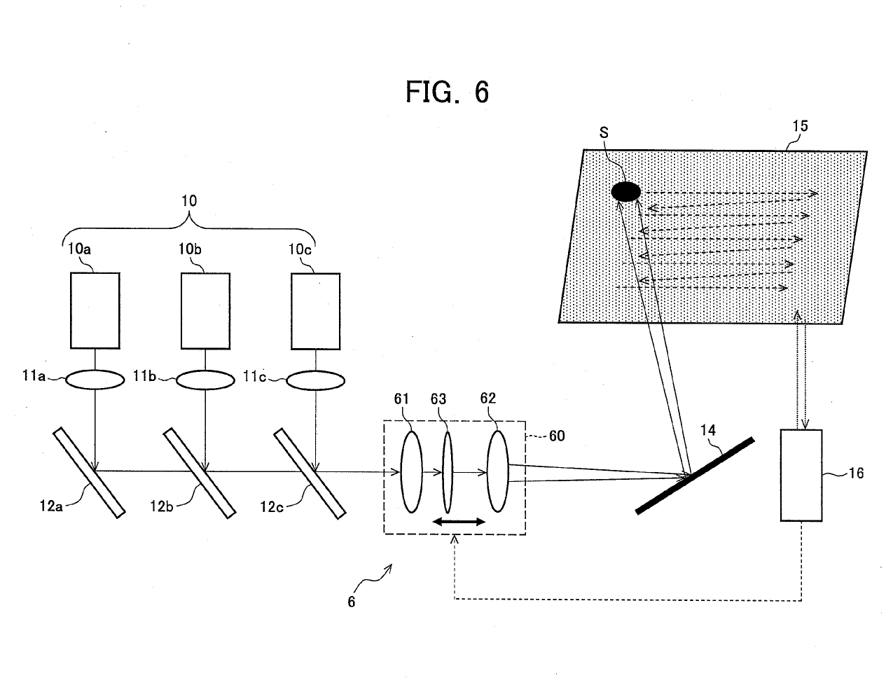

FIG. 6 is a plan schematic of an internal configuration of an image display apparatus according to a fourth embodiment of the present invention and, in FIG. 6, 6 denotes an image display apparatus. In FIG. 6, the same portions as those in the image display apparatus 1 of the first embodiment are denoted by the same reference numerals and will briefly be described by omitting a part of the description including application examples. The description of the reduction of the image quality deterioration due to the projection size is also the same as that of the first embodiment.

The image display apparatus 6 depicted in FIG. 6 is made up of the laser light source device 10 made up of the laser light sources 10a to 10c of R, G, and B, the collimating lenses 11a to 11c that collimate output light beams into parallel lights, the dichroic mirrors 12a to 12c that only reflect wavelengths of their respective light beams, a variable focus device 60 including a plurality of lenses 61 to 63 and a lens moving mechanism, the MEMS mirror 14 that forms an image in a scanning method, the screen 15 that displays an image, and the distance detecting device 16 that detects a distance to the screen 15.

The image display apparatus 6 collimates the light beams emitted from the R, G, and B laser light sources with the collimating lenses 11a to 11c into parallel lights. The laser beams collimated into parallel lights are combined by the dichroic mirrors 12a to 12c to form one light beam. The combined laser beam enters the variable focus device 60 disposed on the light path of the light beam.

The beam diameter of the incident light beam is changed by the variable focus device 60. The variable focus device 60 of this embodiment is made up of a combination of several lenses (the lenses 61 to 63 in the example of FIG. 6) and a portion of lenses (the lens 63 in the example of FIG. 6) can be moved in the light axis direction by the lens moving mechanism such as an actuator. The focused light point of the light beam emitted from the laser light source is controlled by moving the lens to thereby change the beam diameter of the emitted light beam.

The light beam emitted with the beam diameter changed by the variable focus device 60 enters the MEMS mirror 14. The light beam is projected on the screen 15 by the two-axis MEMS mirror 14 to form an image on the screen 15 in the scanning method. The spot size of the light beam projected on the screen 15 is changed depending on the projection size by the variable focus device 60 under control of the control means to prevent the deterioration of image quality. In the same manner as the first embodiment, the variable focus device 60 is driven by the control signal corresponding to the projection size acquired using infrared by the distance detecting device 16.

As described above, in this embodiment, the light beam having a freely controllable beam diameter is projected on the screen 15 to form an image. Therefore, since the light beam projected on the screen 15 has the focused light distance of the light beam controlled by the variable focus distance 60 in this embodiment, the spot size can be changed depending on the projection size to achieve the optimum state of image quality in the same effect as that of the first to third embodiment. Since the change in the spot size can easily be configured using parts with simple mechanism and an image can be formed without expanding the beam diameter in this embodiment, it is possible to make sizes of parts small and reduction of costs.

### Fifth Embodiment

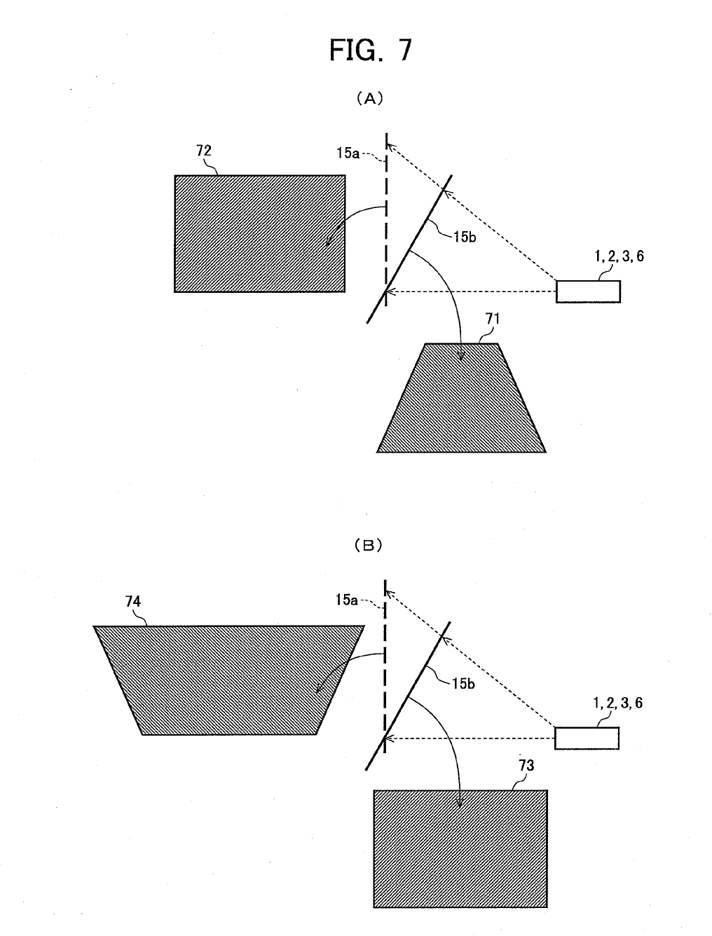

FIG. 7 is a diagram of an example of control of an image display apparatus according to a fifth embodiment of the present invention and 1, 2, 3, and 6 denote the image display apparatuses according to the first, second, third, and fourth embodiments, respectively.

The image display apparatuses 1, 2, 3, and 6 of the first, second, third, and fourth embodiments (hereinafter, exemplarily illustrated by the image display apparatus 1 including the variable focus apparatus 13) have been described without giving particular consideration to the tilt of the screen 15. Therefore, as depicted in FIG. 7(A), a rectangle is projected like an image 72 on a screen 15a disposed substantially parallel to the plane of the MEMS mirror 14 while a trapezoid is projected like an image 71 on a tilted screen 15b.

Such a defect of shape is improvable by detecting a tilt of the screen 15 and accordingly controlling the laser beam to correct the shape. As depicted in FIG. 7(B), control can be performed such that a rectangle is projected like an image 73 even on the screen 15b tilted from the plane of the MEMS mirror 14. If this control is performed, a trapezoid is projected like an image 74 on the screen 15a disposed parallel.

The detection of a tilt can be implemented by including a tile detecting means in the control means. The tile detecting means measures distances for a plurality positions of the screen 15 (preferably, three or more positions) by using the distance detecting device 16 described above to calculate a tilt by geometric operations. For example, a positional relationship of a projected range can be measured by the distance detecting device 16 to obtain a tilt. For example, projection distances can be detected for at least two points such as one point on a scan starting line and one point on a scan ending line of the screen 15 to obtain a tilt in the up-and-down direction. Similarly, projection distances can be detected for two different positions in the horizontal direction to obtain a tilt in the right-and-left direction.

The control of the laser beam for performing the shape correction will be described. For example, if the upper end tilts toward yourself like the screen 15b, a trapezoid is formed with the small upper end and the large lower portion. This must be corrected by gradually reducing the output angle of the light beam as the projection proceeds to the lower side as in the image 71. This may be achieved in two methods that are (I) control of the laser light source and (II) control of the MEMS mirror 14.

The method (I) by means of control of the laser light source includes a method for changing the timing of activating a laser in the laser light source device 10 with the swing angle of the MEMS mirror 14 kept constant. The laser is driven to gradually reduce the activation range in the horizontal direction as the scanning proceeds to the lower side, i.e., such that the laser is activated only for a portion having a gradually reduced output angle. Since this method requires no dynamic control of a movable device such as the MEMS mirror 14 as compared to the method (II) described below, it is possible to improve life time, and the like.

When the activation range is gradually reduced in the horizontal direction, if a light beam is not a parallel light and has a certain spread angle because of design, since a spot size is increased in a lower screen portion that is more distant from the image display apparatus 1, the screen becomes uneven and the image quality deteriorates (a more blurred image is formed on the lower side). However, such deterioration of image quality can be improved by controlling the variable focus device 13 to dynamically change the spot size using the control means, for example, by controlling to make the spot size smaller as the projection proceeds to the lower side in the case of the image 73.

The control means in this case may control the variable focus device 13 to change the sport size in a picture on the screen 15 in accordance with a tilt (tilt angle) of the screen 15 obtained in the same way. If the screen 15 is not rightly faced (projected in parallel) and tilts, the control means always dynamically changes the spot size continuously while an image is displayed. On the other hand, if rightly faced, the control is basically performed such that the optimum spot size is formed for the projection size and, subsequently, an image may be displayed with the constant spot size.

Alternatively, the control means may control the variable focus device 13 to directly change the spot size in accordance with the distance at the scanning point acquired from the distance detecting device 16. Such control also corresponds to the control of indirectly changing the spot size in accordance with a tilt of the screen 15. In a simpler configuration, a projection distance may be detected between two points of the scan starting point and the scan ending point of the screen 15 to determine and control the spot size based on such a projection distance that interpolates the two points.

The method (II) by means of control of the MEMS mirror 14 is a method for dynamically changing the swing angle of the MEMS mirror 14. The MEMS mirror 14 is controlled such that the swing angle is reduced as the lower side of the screen is displayed. Although the spot size varies depending on a portion of the screen and the image quality deteriorates since the screen 15b is tilted if a light beam is not a parallel light and has a certain spread angle because of design, this can also be improved by dynamically controlling the variable focus device 13 depending on the tilt.

Therefore, regardless of whether the screen 15 is tilted or not, it is possible to obtain the spot size depending on the tilt of the screen 15 and acquire an optimum quality image by correcting the projected shape by means of controlling the laser beam and variably controlling the size of the beam diameter for each projection position on the screen 15 by the control means and the variable focus device 13. Although the methods (I) and (II) have been described on the basis that the light beam is not parallel light, since the image quality varies depending on the projection size if the emitted light is parallel light, it is better to adjust the spot size even in the case of parallel light.

### Sixth Embodiment

Although the control means controls the variable focus device to change the spot size in accordance with the projection size in the image display apparatuses according to the first to fifth embodiments, an image display apparatus according to a sixth embodiment controls the variable focus device in accordance with user's operation instead of the projection size (projection distance) or as fine adjustment after the control in accordance with the projection size.

The control means of the image display apparatus of this embodiment has an operation means that accepts the user's operation for changing the spot size, and controls the variable focus device to change the spot size in accordance with the user's operation accepted by the operating means. Such an operation means, i.e., user interface, may entirely be disposed and included in the image display apparatus by providing an adjustment lever or an adjustment knob, or may have a portion that allows the user's operation to be executed on the video source side such as a television or PC connected to the image display apparatus to receive an operation signal.

By enabling a user to freely adjust the variable focus device, the image quality can freely be set in accordance with user's preferences. As a result, it is possible to make this image display apparatus have various purposes.

Since a degree of overlap between pixels actually varies depending on the spot size, a resolution feeling is changed in the image quality felt by a viewer that is a user. If the overlap is small, the image quality is sharp, and the sharpness decreases as the overlap increases. However, since the control means described above enables a user to freely adjust the spot size in this embodiment, a user can adjust the degree of overlap. Therefore, this embodiment enables the resolution feeling of an image to be adjusted in accordance with user's preferences and the image quality to be consequently adjusted in accordance with user's preferences.

Although the embodiments of the present invention have been described on the bases that scanning is performed after R, G, and B are combined, a variable focus device and a MEMS mirror may be provided for each of R, G, and B to employ a configuration of performing the combination after the scanning (e.g., on a screen), for example. In this case, since a color of each pixel is represented by overlapping the RGB light beams, the pitches and beam diameters must be the same among R, G, and B so as to maintain image quality.

1.-11. (canceled)

12. An image display apparatus comprising: a light source device that emits a light beam; a scanning type image forming means that forms an image on a screen; a variable focus device disposed on a light path which the light beam emitted from the light source device reaches the image forming means; and a control means that controls the variable focus device, wherein the control means controls the variable focus device to change a spot size of a light beam projected on the screen in accordance with a projection size that is a projected image size on the screen.

13. The image display apparatus as defined in claim 12, comprising a projection size detecting means that detects the projection size, wherein the control means controls the variable focus device to change the spot size in accordance with the projection size detected by the projection size detecting means.

14. The image display apparatus as defined in claim 13, wherein the projection size detecting means is a distance detecting means that detects a projection distance to the screen and wherein the control means controls the variable focus device to change the spot size in accordance with the projection size corresponding to the projection distance detected by the distance detecting means.

15. The image display apparatus as defined in claim 12, wherein the control means has an operating means that accepts a user's operation for changing the spot size and wherein the control means controls the variable focus device to change the spot size in accordance with the user's operation accepted by the operating means.

16. The image display apparatus as defined in any one of claims 12 to 15, wherein the variable focus device has an element capable of electrically controlling the spot size.

17. The image display apparatus as defined in claim 16, wherein the variable focus device has a liquid crystal lens as the element to change the spot size through voltage control applied to the liquid crystal lens.

18. The image display apparatus as defined in claim 16, wherein the variable focus device has a liquid lens as the element to change the spot size through voltage control applied to the liquid lens.

19. The image display apparatus as defined in claim 16, wherein the variable focus device has a variable focus mirror having a variable curved surface shape of the mirror as the element to change the spot size through voltage control applied to the variable focus mirror.

20. The image display apparatus as defined in claim 19, wherein the variable focus device controls a shape of a spot on the screen into a substantially rectangular shape.

21. The image display apparatus as defined in any one of claims 12 to 15, wherein the variable focus device has a plurality of lenses and a lens moving mechanism that moves at least one of the lenses in the light axis direction to change the spot size by moving the lens with the lens moving mechanism.

22. The image display apparatus as defined in any one of claims 12 to 15, wherein the control means has a tilt detecting means that detects a tilt of the screen and wherein the control means controls the variable focus device to change a spot size in a picture on the screen in accordance with the tilt detected by the tilt detecting means.
